(19) United States
(12) Patent Application Publication
(10) Pub. No.: US 2024/0235148 A1
(43) Pub. Date: Jul. 11, 2024

(54) Enhancing The Stability Of Quantum Noise Limited Feedback Oscillators

(71) Applicant: Massachusetts Institute of Technology, Cambridge, MA (US)

(72) Inventors: Hudson Alexander Loughlin, Boston, MA (US); Vivishek Sudhir, Cambridge, MA (US)

(21) Appl. No.: 18/398,383

(22) Filed: Dec. 28, 2023

Related U.S. Application Data
(60) Provisional application No. 63/477,416, filed on Dec. 28, 2022.

(51) Int. Cl. H01S 3/13; H01S 3/094; H01S 3/1112; H01S 3/16

(52) U.S. Cl. CPC H01S 3/1305; H01S 3/094026; H01S 3/1112; H01S 3/1304; H01S 3/1307; H01S 3/1683

(57) ABSTRACT

A feedback oscillator, with an amplifier whose output is partially fed back to its input, provides a stable reference for standardization and synchronization. The laser is a feedback oscillator whose performance can be limited by quantum fluctuations. The resulting frequency instability, quantified by the Schawlow-Townes formula, sets a limit to laser linewidth. Here, we show that the Schawlow-Townes formula applies to feedback oscillators beyond lasers. This is because it arises from quantum noise added by the amplifier and an out-coupler in the feedback loop. Tracing the origin of quantum noise in an oscillator informs techniques to systematically evade it: squeezing and entanglement can enable sub-Schawlow-Townes linewidth feedback oscillators. We clarify the quantum limits to the stability of feedback oscillators, derive a standard quantum limit (SQL) for feedback oscillators, and disclose quantum strategies for realizing sub-SQL feedback oscillators.

### CROSS-REFERENCE TO RELATED APPLICATION(S)

This application claims the priority benefit, under 35 U.S.C. § 119(e), of U.S. Application No. 63/477,416, which was filed on Dec. 28, 2022, and is incorporated herein by reference in its entirety for all purposes.

### GOVERNMENT SUPPORT

This invention was made with government support under PHY1764464 awarded by the National Science Foundation. The government has certain rights in the invention.

### BACKGROUND

A feedback oscillator is an oscillator that relies on positive feedback to sustain oscillations. Feedback oscillators suffuse the modern world, and their stability demarcates what is possible in every conceivable enterprise. Frequency fluctuations of oscillators limit measurements of distance—using a radar, lidar, or for gravitational-wave detection—and of time using optical atomic clocks. The performance of information processors—classical or quantum—and communication systems are also limited by the stability of their clocks. So is our sensitivity to new physics—at low energy or using high-energy colliders; and of our planet, or the universe. Even modern economic practice is beholden to the ticks of a clock.

A paradigmatic example of a feedback oscillator whose stability is well understood is the laser. A laser's frequency noise is given by the (modified) Schawlow-Townes (ST) formula,

$${\overline{S}}_{\dot{φ} \dot{φ}}^{S T} [ Ω ] = \frac{ℏ {Ω}_{0} {κ}^{2}}{{P}_{0}} ( \frac{1}{2} + {n}_{t h} ) = {( \frac{ln η}{τ \vert α \vert} )}^{2} ( \frac{1}{2} + {n}_{t h} ) , \qquad ( 1 )$$

for the symmetrized double-sided spectrum of the frequency deviation \dot{φ} from the oscillator's nominal output frequency Ω₀. Here, P₀=ℏΩ₀|a|² is the laser's mean output power and a is the amplitude of the mean photon flux. In a laser, the feedback element is a cavity, whose round-trip time is τ and average thermal occupation is nₜₕ=[exp(ℏΩ₀/k_{B}T)−1]⁻¹. Light is coupled out of the laser cavity through a mirror with power reflectivity n, equivalent to the cavity linewidth κ=τ⁻¹lnη.

The Schawlow-Townes formula is more commonly specified as a linewidth instead of a spectral density. The full-width-at-half-maximum linewidth Γ of a signal with with flat frequency noise spectrum is, Γ=S [symbol] /(21π), so the linewidth corresponding to Eq. (1) is

$${Γ}_{S T} = \frac{1}{2 π} {( \frac{ln η}{τ \vert α \vert} )}^{2} ( \frac{1}{2} + {n}_{t h} ) . \qquad ( 2 )$$

When the average thermal occupation is 0 (i.e., nₜₕ=0), the feedback oscillator's performance is limited by quantum noise.

### SUMMARY

Here, we show that the Schawlow-Townes limit applies to a much larger class of feedback oscillators: feedback oscillators that are constructed by positive feedback of the output of a broadband amplifier. In doing so, we precisely identify the origin of the Schawlow-Townes limit, extend the well-known theory of quantum noise in amplifiers to oscillators, and establish a bridge between the classical electronic theory of feedback oscillators and the quantum electronics of a laser. Based on these insights, we present ways of evading the Schawlow-Townes bound by manipulating the oscillators' quantum states. Squeezing, entanglement, and phase-sensitive amplification in feedback oscillators make it possible to achieve stability beyond the Schawlow-Townes limit, providing a new avenue towards realizing ultra-stable oscillators.

An example feedback oscillator includes a source, phase-sensitive amplifier, and phase stabilizer, which is operably coupled to the source and the phase-sensitive amplifier. In operation, the source emits coherent radiation, the phase-sensitive amplifier emits a squeezed field, and the phase stabilizer stabilizes a phase of the coherent radiation relative to a phase of the squeezed field. The feedback oscillator may emit an output with a linewidth below the Schalow-Townes limit.

The phase-sensitive amplifier can amplify an amplitude quadrature of the coherent radiation. In some cases, the phase-sensitive amplifier emits the squeezed field as a squeezed vacuum. In other cases, the phase-sensitive amplifier emits the squeezed field as a squeezed bright field. The phase-sensitive amplifier may include a phase-insensitive amplifier to amplify the coherent radiation and a squeezer, operably coupled to the phase-insensitive amplifier, to generate the squeezed field from the coherent radiation.

The feedback oscillator can be an optoelectronic oscillator, in which case the source may include a laser, the phase-sensitive amplifier may include an optical parametric amplifier configured to emit the squeezed field as a squeezed bright field, and the phase stabilizer may include a feedback loop configured to lock a phase of the coherent radiation to the optical parametric amplifier. This optical parametric amplifier can be in a positive feedback loop configured to act on a modulated copy of the coherent radiation. The feedback oscillator can also include an amplitude modulator, in optical communication with the laser, to modulate an amplitude of the coherent radiation; a delay line, in optical communication with the amplitude modulator and the phase-sensitive amplifier, to delay the coherent radiation; a photodetector, in optical communication with the phase-sensitive amplifier, to transduce the squeezed bright field into a radio-frequency signal dominated by shot noise generated by detection of the squeezed bright field; and a power splitter, operably coupled to the photodetector and the amplitude modulator, to drive the amplitude modulator with a first portion of the radio-frequency signal and to emit a second portion of the radio-frequency signal as an output of the feedback oscillator.

The optical parametric amplifier can include a pump laser to emit a pump beam; a radio-frequency synthesizer to generate a local oscillator; a mixer, operably coupled to the radio-frequency synthesizer and to the photodetector, to mix the local oscillator with a component of the radio-frequency signal so as to generate an error signal; and a phase modulator, operably coupled to the mixer and the pump laser, to modulate a phase of the pump beam in response to the error signal. The mixer can control a squeezing angle of the squeezed bright field. The optical parametric amplifier can also include a second-order nonlinear medium, disposed in cavity in optical communication with the pump laser, to generate the squeezed bright field via a parametric interaction between the pump beam and the coherent radiation.

Alternatively, the feedback oscillator can be a laser configured to emit a laser beam, in which case the source may include a gain medium in a laser cavity of the laser, the phase-sensitive amplifier may include an optical parametric amplifier configured to emit the squeezed field as a squeezed vacuum and to couple the squeezed vacuum into the laser cavity, and the phase stabilizer may be configured to lock a phase angle of the optical parametric amplifier to a phase of the laser beam. The optical parametric amplifier may include a pump laser to generate a pump beam and a second-order nonlinear medium to generate the squeezed vacuum via a parametric interaction between the pump beam and the laser beam. The phase stabilizer can align a phase quadrature of the squeezed vacuum to a phase quadrature of the laser beam.

In another embodiment, the feedback oscillator is an optical parametric oscillator configured to emit an output at an output frequency, in which case the source may include a pump laser that emits the coherent radiation at a pump frequency equal to twice the output frequency, the phase-sensitive amplifier may include a nonlinear medium in a cavity and configured to emit the squeezed field as a squeezed bright field at the output frequency, and the phase stabilizer may include to stabilize the pump frequency to the cavity.

The feedback oscillator can also be implemented as a Josephson parametric oscillator, in which case the source may include a pump transmission line, the phase-sensitive amplifier may include a superconducting quantum interference device (SQUID) loop, and the phase stabilizer may include a superconducting transmission line and a capacitor impedance-matched to a pump transmission line.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A shows representations of feedback oscillators based on phase-insensitive amplifiers, such as lasers (lower left) and phase-shift oscillators (lower right), where the amplifier output is fed back with a unitary element, here modeled by a beam splitter.

FIG. 1B shows representations of feedback oscillators based on phase-sensitive amplifiers, such as optical parametric oscillators (OPOs) and Josephson parametric oscillators (JPOs), where a portion of the output of a phase-sensitive amplifier (dashed rectangle, composed of a phase-insensitive amplifier followed by an ideal squeezer) is fed back into the phase-sensitive amplifier's input.

FIG. 1C is a phase-space diagram showing a sketch of the carrier field (solid arrow) and vacuum fluctuations (circle) in the two quadratures q, p. These fluctuations cause the oscillators' amplitude and phase to fluctuate.

FIG. 1D shows a frequency-domain picture of the carrier at 20 (arrow) that is selectively amplified by the overlapping gain profiles of the in-loop amplifier (Gaussian trace) and the resonant harmonics of the feedback loop (arrows offset from Ω₀).

FIG. 2 is a plot of the output phase quadrature spectrum of a feedback oscillator with a phase-insensitive in-loop amplifier. The output phase quadrature spectrum is well approximated near the carrier by a second-order pole, producing a Lorentzian line shape. The lower trace shows the Schawlow-Townes component of the lineshape near the carrier, while the upper trace shows the full prediction [Eq. (16)] including the white vacuum noise far from (middle trace).

FIG. 3 is a plot of spectra of the output phase quadrature for four types of quantum-noise-limited oscillators. The upper trace shows the Schawlow-Townes spectrum of an oscillator with phase-insensitive amplifier and the in-coupled and ancillary modes in vacuum. The upper middle and lower middle traces depict the cases where these modes are squeezed and entangled, respectively (both with 12 dB of squeezing). The lower trace shows the case where the in-loop amplifier is purely phase-sensitive. The horizontal line is at S̅ₚₚ^{out} ½ for reference.

FIG. 4A shows a phase-sensitive amplifier.

FIG. 4B illustrates a decomposition of the phase-sensitive amplifier of FIG. 4A into a phase-insensitive amplifier followed by a squeezer.

FIG. 5A illustrates an optoelectronic oscillator (OEO) with a phase-sensitive amplifier that generates a bright squeezed light output for stabilizing the output frequency of the OEO.

FIG. 5B illustrates an optical parametric amplifier (OPA) suitable for use as the phase-sensitive amplifier in the OEO of FIG. 5A.

FIG. 6 illustrates a laser with squeezed light injected into its gain medium via its input/output mirror for stabilization below the Schawlow-Townes limit.

FIG. 7 illustrates an OPO with a second-order nonlinear medium that provides phase-sensitive amplification for stabilization below the Schawlow-Townes limit.

FIG. 8 illustrates a cryogenically cooled JPO with a superconducting quantum interference device (SQUID) loop that provides both coherent radiation and phase-sensitive amplification and a superconducting transmission line that provides passive phase stabilization.

### DETAILED DESCRIPTION

The Schawlow-Townes limit is applicable to a wide class of feedback oscillators. In fact, for a phase-insensitive, quantum-noise-limited oscillator, it is one facet of a more general standard quantum limit (SQL) for the oscillator's outgoing field (“standard” here meaning a setting where no additional quantum strategies are employed). This SQL dictates the trade-off between the frequency and power fluctuations of a broad class of feedback oscillators. However, systematic strategies such as injection of squeezed vacuum, Einstein-Podolsky-Rosen (EPR) entanglement, and phase-sensitive amplification offer sufficient room to evade the Schawlow-Townes limit and thereby realize ultra-stable feedback oscillators. Such an ultra-stable feedback oscillator can have stability beyond that of any feedback oscillator with the same output power, feedback delay time, and out-coupler transmissivity that does not manipulate the oscillator's quantum states. By engineering a feedback oscillator's quantum states, we can engineer ultra-stable feedback oscillators with stability beyond the Schawlow-Townes limit.

An ultra-stable feedback oscillator may include a source of coherent radiation, a phase-sensitive amplifier, and a mechanism for keeping the phase relationship between the coherent radiation and the phase-sensitive amplifier's output stable. For instance, the source and phase-sensitive amplifier can be in a feedback loop that supports an ultra-stable oscillating mode. A beam splitter or output coupler in the feedback loop couples a portion of this mode out of the feedback loop as the feedback oscillator's ultra-stable output.

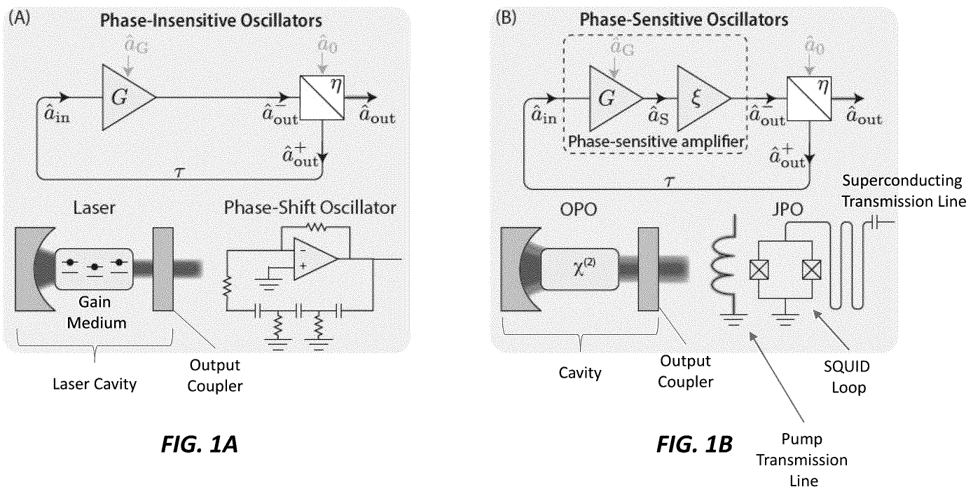

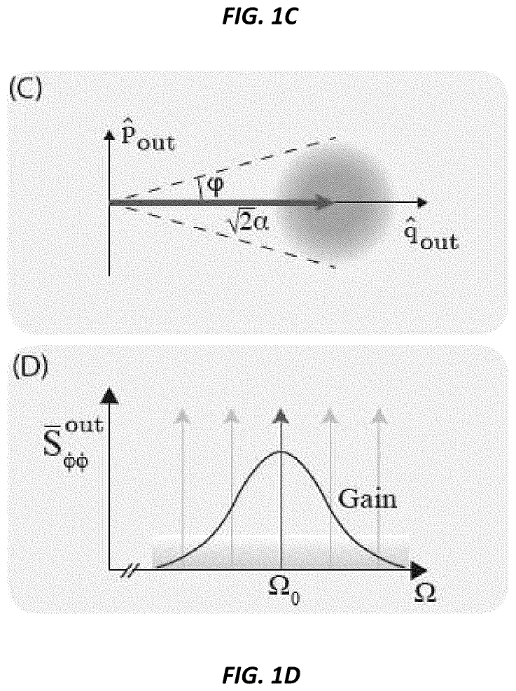

FIG. 1A shows different feedback oscillators based on phase-insensitive amplifiers. The upper portion of FIG. 1A shows a schematic of a simple feedback oscillator consistent with the laws of quantum physics: a phase-insensitive amplifier with linear gain G embedded in a feedback loop of time delay t, whose output, because of the no-cloning theorem, is extracted from the loop using a beam splitter. The mode do â₀ adds quantum noise at the feedback oscillator's out-coupler (the output port of the beam splitter). This simple feedback oscillator architecture can be implemented as a conventional laser (lower left) or a conventional electronic phase-shift oscillator (lower right). In the laser, the gain medium and laser cavity provide the phase-insensitive amplifier and feedback loop, respectively. The laser's output is coupled out of the laser cavity via a partially transmitting mirror, or output coupler. In the electronic phase-shift oscillator, an operational amplifier (op amp) provides the gain. One of the op amp's input ports is coupled to ground and the other input port is coupled to the op amp's output port in a feedback loop.

In the absence of the feedback loop, the observation of Haus-Caves is that the classical input-output relation [symbol] âₒᵤₜ⁻ [symbol] =G [symbol] \hat{α}ᵢₙ [symbol] cannot be promoted to the relation between operators \hat{α}ₒᵤₜ⁻(t)=G\hat{α}ᵢₙ(t), since that is inconsistent with the commutation relations (here i, j ∈{in, out})

$$[ {\hat{a}}_{i} ( t ) , {\hat{a}}_{j}^{†} ( {t}^{′} ) ] = δ ( t - {t}^{′} ) {δ}_{i j} . \qquad ( 3 )$$

Consistency can be achieved by modifying the input-output relation to

$${\hat{a}}_{out}^{-} ( t ) = G {\hat{a}}_{i n} ( t ) + \sqrt{{G}^{2} - 1} {\hat{a}}_{G}^{†} ( t ) , \qquad ( 4 )$$

where the ancillary mode \hat{α}_{G} is such that [\hat{α}_{G}(t), \hat{α}_{G}⁺(t′)]=δ(t−t′) and [symbol] \hat{α}_{G}(t) [symbol] =0. Physically, it conveys unavoidable noise added by the amplifier's internal degrees of freedom.

These observations do not apply when the feedback loop in the feedback oscillator is closed. First, positive feedback leads to a large mean field at the input of the amplifier, which saturates its output due to its intrinsic nonlinearity. Nonlinearity in the response is fundamental to a physical amplifier since its gain arises from an external source with finite energy density. This nonlinearity determines the amplitude of the oscillating output field (as discussed below). Secondly, the commutation relations in Eq. (3) only apply to freely propagating fields, not those inside a feedback loop. A proper account of the saturation behavior leads to the threshold condition for oscillation, i.e., “gain=loss”, while a proper imposition of the commutation relation gives the correct quantum noise of the oscillator.

### Saturation, Steady-State, and Linear Gain

The nonlinear input-output behavior of the (memoryless) amplifier can be cast as

$${α}_{out}^{-} ( t ) = 𝒜 ( {α}_{i n} ( t ) ) , \qquad ( 5 )$$

where aᵢ= [symbol] âᵢ [symbol] (i∈{in, out}) is the mean amplitude and [symbol] (⋅) is a nonlinear gain function, which we postulate has the following properties: (1) [symbol] (−x)=− [symbol] (x), i.e., the amplifier is symmetric and bipolar; (2) d [symbol] /dx>0, ∀x, i.e., the amplifier's output is a monotonically increasing function of its input; (3) [symbol] (x→0)→G₀x for some G₀>1/\sqrt{η}, i.e., there exists a “small signal” regime of linear gain G₀, such that this gain is larger than the loss via the out-coupler, parametrized by \sqrt{η}; and (4) d² [symbol] /dx²<0, i.e., the instantaneous gain, d [symbol] /dx, is a monotonically decreasing function of the amplifier's input. (The weaker condition that d² [symbol] /dx²<0at the smallest value of x for which d [symbol] /dx=1/\sqrt{η} is sufficient to ensure stability against infinitesimal perturbations; condition (4) ensures stability against finite perturbations as explained below.)

The output of the amplifier αₒᵤₜ⁻(t) propagates through the feedback loop and appears as

$${α}_{i n} ( t ) = - \sqrt{η} {α}_{out}^{-} ( t - τ ) + \sqrt{1 - η} {α}_{0} ( t - τ ) \qquad ( 6 )$$

at the input of the amplifier. The classical, nonlinear, input-output relations, Eqs. 5 and 6, together with the postulates of the nonlinear gain, [symbol] , suffice to determine the oscillator's classical steady state.

As discussed in detail below, the oscillator should begin at an unstable equilibrium point with zero output field amplitude. Any perturbation, such as noise, should then kick the oscillator away from the unstable equilibrium and initiate oscillations, just as in a laser. Small signal analysis shows that this oscillatory state is stable if the in-loop field amplitude, αₛₛ, satisfies

$$\vert 𝒜 [ {α}_{s s} ] \vert = {α}_{s s} / \sqrt{η} . \qquad ( 7 )$$

The corresponding output, α=\sqrt{η}ₛₛ, determines the oscillator's amplitude, and serves as the phase reference for quantum fluctuations discussed here. The linear gain of the amplifier in this steady state is

$$G ≡ {lim}_{t \to + ∞} {α}_{out}^{-} ( t ) / {α}_{i n} ( t ) = 1 / \sqrt{η} . \qquad ( 8 )$$

This equation has the form “gain=loss” and defines the linear gain seen by the quantum fluctuations that ride on top of the classical steady state.

### Quantum Fluctuations

Around the steady state, the (Heisenberg-picture) operators representing the quantum fluctuations satisfy the set of linear equations:

$$\begin{matrix}{\hat{a}}_{out}^{-} [ Ω ] = G {\hat{a}}_{in} [ Ω ] + \sqrt{{G}^{2} - 1} {\hat{a}}_{G}^{†} [ Ω ] \\ {\hat{a}}_{out}^{+} [ Ω ] = - \sqrt{η} {\hat{a}}_{out}^{-} [ Ω ] + \sqrt{1 - η} {\hat{a}}_{0} [ Ω ] \\ {\hat{a}}_{out} [ Ω ] = \sqrt{1 - η} {\hat{a}}_{out}^{-} [ Ω ] + \sqrt{η} {\hat{a}}_{0} [ Ω ] \\ {\hat{a}}_{in} [ Ω ] = {e}^{i Ω τ} {\hat{a}}_{out}^{+} [ Ω ] ,\end{matrix} \qquad ( 9 )$$

which can be expressed in terms of their Fourier transforms. Here G is the linear gain of the amplifier, the ancillary mode â_{G} describes the unavoidable noise associated with amplification, and the last equation is the Fourier transform of the time-domain relation, âᵢₙ^{-(t)=â}ₒᵤₜ⁺(t−τ), expressing the delay in the feedback path. The amplifier's gain is taken to be frequency-independent for frequencies comparable to the inverse delay of the loop.

The quantum statistics of the ancillary mode, â_{G}, in closed-loop operation of a feedback oscillator (i.e., 0<η<1), need not coincide with those in open-loop operation (η=0). In the closed-loop configuration, since the ancillary mode is not freely propagating, it need not satisfy the commutation relations (the Fourier transform analog of Eq. (3))

$$[ {\hat{a}}_{i} [ Ω ] , {\hat{a}}_{j}^{†} [ {Ω}^{′} ] ] = 2 π \cdot δ [ Ω + {Ω}^{′} ] {δ}_{ij} . \qquad ( 10 )$$

of a freely propagating field. However, the fields in-coupled and out-coupled from the oscillator, â₀and âₒᵤₜ, are freely propagating and should obey Eq. (10). To enforce this constraint, we solve Eq. (9) expressing the output in terms of the in-coupled and ancillary fields:

$${â}_{out} [ Ω ] = {H}_{0} [ Ω ] {â}_{0} [ Ω ] + {H}_{G} [ Ω ] {â}_{G}^{†} [ Ω ] , \qquad ( 11 )$$

where the transfer functions are

$${H}_{0} [ Ω ] = \frac{\sqrt{η} + {e}^{i Ω τ} / \sqrt{η}}{1 + {e}^{i Ω τ}} , {H}_{G} [ Ω ] = \frac{1 / \sqrt{η} - \sqrt{η}}{1 + {e}^{i Ω τ}} . \qquad ( 12 )$$

Here we have assumed steady-state operation in which [Eq. (8)]G \sqrt{η}=1. Insisting that âₒᵤₜ â₀satisfy Eq. (10) forces the ancillary mode to satisfy

$$\begin{matrix}[ {â}_{G} [ Ω ] , {â}_{G}^{†} [ {Ω}^{′} ] ] = \frac{{\vert {H}_{0} [ Ω ] \vert}^{2} - 1}{{\vert {H}_{G} [ Ω ] \vert}^{2}} 2 π \cdot δ [ Ω + {Ω}^{′} ] \\ = 2 π \cdot δ [ Ω + {Ω}^{′} ] ,\end{matrix} \qquad ( 13 )$$

where we have used the fact that |H₀[Ω]|²−|H_{G}[Ω]|²−1. Thus, although â_{G} is not freely propagating, it should obey the usual canonical commutation relation.

### The Output Spectrum and Schawlow-Townes Formula

For an arbitrary output field âᵢ, the amplitude and phase quadratures are defined by \hat{q}ᵢ=(âᵢ^{†}+âᵢ)/\sqrt{2} and \hat{p}ᵢ=i(âᵢ^{†}−âᵢ)/\sqrt{2}. Eq. (11) can then be written as

$$\begin{matrix}{\hat{q}}_{out} [ Ω ] = {H}_{0} [ Ω ] {\hat{q}}_{0} [ Ω ] + {H}_{G} [ Ω ] {\hat{q}}_{G} [ Ω ] \\ {\hat{p}}_{out} [ Ω ] = {H}_{0} [ Ω ] {\hat{p}}_{0} [ Ω ] - {H}_{G} [ Ω ] {\hat{p}}_{G} [ Ω ]\end{matrix} . \qquad ( 14 )$$

Assuming that the in-coupled and ancillary modes are in uncorrelated vacuum states, i.e., S̅_{qq}⁰=pp =S̅ₚₚ⁰=S̅_{qq}^{G}=S̅ₚₚ^{G}=½ and all cross-spectra are identically zero, the output quadrature spectra are

$${\overline{S}}_{q q}^{o u t} [ Ω ] = {\overline{S}}_{p p}^{o u t} [ Ω ] = \frac{1}{2} ( \vert {H}_{0}^{2} [ Ω ] \vert + \vert {H}_{G}^{2} [ Ω ] \vert ) .$$

Using the explicit forms of the transfer functions in Eq. (12) gives:

$${\overline{S}}_{q q}^{o u t} [ Ω ] = {\overline{S}}_{p p}^{o u t} [ Ω ] = \frac{{( \sqrt{η} - 1 / \sqrt{η} )}^{2}}{4 {cos}^{2} ( Ωτ / 2 )} + \frac{1}{2} . \qquad ( 15 )$$

The frequencies Ωₙ:=(2n+1)π/τ (for some integer n) at which these spectra are singular are the poles of the transfer functions H₀, H_{G}, and are therefore the frequencies of steady-state oscillations of the closed loop. Physically, they correspond to constructive interference after subsequent traversals of the feedback loop. In a practical feedback oscillator, the gain G[Ω] is typically engineered to sustain only one steady state at, say, frequency Ω₀as in FIG. 1D. Then the output field has a single carrier of amplitude a=\sqrt{η}aₛₛ that leaks out of the loop. The above-mentioned quadratures then represent fluctuations around this carrier. Defining a frequency offset ω from the carrier, i.e., Ω=Ω₀+ω where ωτ<<1, the phase quadrature spectrum in Eq. (15) assumes the approximate form

$${\overline{S}}_{p p}^{o u t} [ {Ω}_{0} + ω ] \approx \frac{{( \sqrt{η} - 1 / \sqrt{η} )}^{2}}{{( ω τ )}^{2}} + \frac{1}{2} . \qquad ( 16 )$$

The first term is the near-carrier Lorentzian-shaped vacuum noise of the oscillator's output while the second term is the away-from-carrier white vacuum noise.

As it happens, the near-carrier noise described by the first term in Eq. (16) is equivalent to the Schawlow-Townes formula. To see this, we describe the phase fluctuation of the output field |a|² by the operator, \hat{φ}≈\hat{p}ₒᵤₜ/(\sqrt{2}|α|). (In this instance, the large photon flux of the output field |α|² circumvents the technical difficulties in constructing a Hermitian phase operator.) Thus, the frequency spectrum of the output around the carrier is [symbol] [Ω₀+ω]=ω²S̅_{φφ0}[Ω₀+ω]=(ω²/|a|²)Sₚₚ^{out}[Ω₀+ω]. Using Eq. (16), this is

$${\overline{S}}_{\dot{φ} \dot{φ}}^{S T} [ {Ω}_{0} + ω ] \approx \frac{{( \sqrt{η} - 1 / \sqrt{η} )}^{2}}{2 {τ}^{2} {\vert α \vert}^{2}} + \frac{{( ω τ )}^{2}}{4 {τ}^{2} {\vert α \vert}^{2}} \approx \frac{{( 1 - η )}^{2}}{2 {τ}^{2} {\vert α \vert}^{2}} . \qquad ( 17 )$$

Here we have omitted the second term, which arises from the frequency-independent vacuum noise ½ in Eq. (16) and is negligible close to the carrier. The resulting expression is the Schawlow-Townes formula in its regime of applicability (a laser with a highly reflective out-coupler, i.e., η≈1, in which case Eqs. (1) and (17) agree to [symbol] [(1−η)³]).

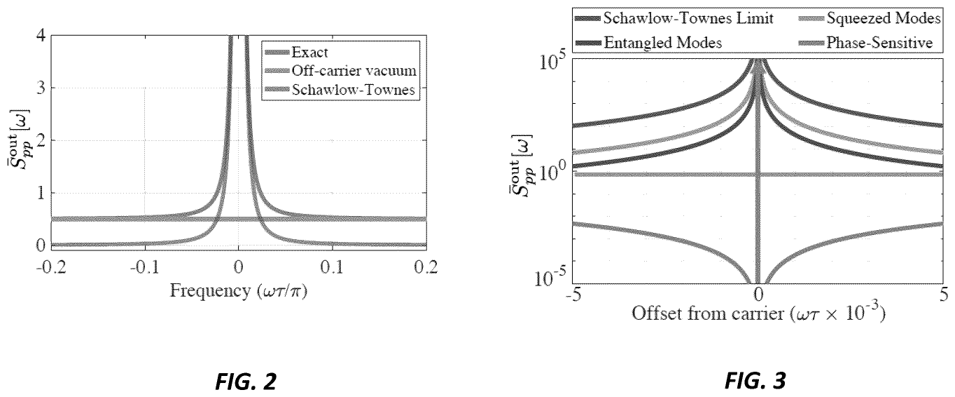

FIG. 2 compares a quantum-noise-limited oscillator's exact output phase spectrum (upper trace) to the Schawlow-Townes formula (lower trace). More specifically, the upper trace shows the trace given by Eq. (16), which is the full prediction, including white vacuum noise far from carrier, which is also plotted as the horizontal trace. The second-order pole in Eq. (16) produces a Lorentzian lineshape. The lower trace shows the Schawlow-Townes component of the lineshape near the carrier. Comparing the upper and lower traces shows that the Schawlow-Townes formula for a quantum-limited feedback oscillator in Eq. (17) arises from quantum vacuum noise added by the in-loop amplifier and the out-coupler of the feedback oscillator.

### Standard Quantum Limit for Feedback Oscillators

We now derive a trade-off between the phase and amplitude fluctuations of the output of a feedback oscillator, contextualize the Schawlow-Townes formula within it, illustrate how squeezed fields can help evade the Schawlow-Townes limit for the phase at the expense of increased power fluctuations, and how entangled fields or a phase-sensitive, in-loop amplifier can circumvent the trade-off altogether.

The output field quadratures satisfy the canonical commutation relations [\hat{q}ₒᵤₜ(τ), \hat{p}ₒᵤₜ(τ′)]=iδ(τ−τ′). This implies that

$${\overline{S}}_{q q}^{o u t} [ Ω ] {\overline{S}}_{p p}^{o u t} [ Ω ] \geq \frac{1}{4} ; \qquad ( 18 )$$

a Heisenberg uncertainty principle for the spectra of these quadratures. This constraint is independent of the physics of a feedback oscillator and is thus too lax to derive a trade-off between the phase and amplitude fluctuations of a feedback oscillator's output.

To derive a tighter constraint, we use Eq. (14) to relate the output spectra to the in-coupled and ancillary spectra. For each quadrature x={q, p},

$$\begin{matrix}{\overline{S}}_{q q}^{o u t} = {\vert {H}_{0} \vert}^{2} {\overline{S}}_{x x}^{0} + {\vert {H}_{G} \vert}^{2} {\overline{S}}_{x x}^{G} \pm 2 Re [ {H}_{0}^{*} {H}_{G} {\overline{S}}_{x x}^{0 , G} ] \\ \geq 2 \vert {H}_{0} {H}_{G} \vert ( \sqrt{{\overline{S}}_{x x}^{0} {\overline{S}}_{x x}^{G}} - \vert {\overline{S}}_{x x}^{0 , G} \vert ) ,\end{matrix} \qquad ( 19 )$$

where S̅_{qq}^{0,G}≡S̅_{q0G}, etc. The inequality follows from the fact that a+b≥2\sqrt{ab}, valid for any a, b≥0, and that −|z|≤Re(z)≤|z| for any complex number z. In the first line of Eq. (19), the plus sign applies for the amplitude quadrature and the negative sign for the phase quadrature. However, the inequality applies for both quadratures. Using Eq. (19), the output quadrature spectra satisfy the constraint

$${\overline{S}}_{q q}^{o u t} {\overline{S}}_{p p}^{o u t} \geq 4 {\vert {H}_{0} {H}_{G} \vert}^{2} \times ( \sqrt{{\overline{S}}_{q q}^{0} {\overline{S}}_{q q}^{G}} - \vert {\overline{S}}_{q q}^{0 , G} \vert ) ( \sqrt{{\overline{S}}_{p p}^{0} {\overline{S}}_{p p}^{G}} - \vert {\overline{S}}_{p p}^{0 , G} \vert ) , \qquad ( 20 )$$

which applies to all phase-insensitive feedback oscillators.

If the modes â₀ and â_{G} are uncorrelated, the cross-terms S̅_{qq}^{-0,G} and S̅ₚₚ^{0,G} vanish. Because the modes â₀ and â_{G} satisfy the canonical commutation relations, it follows that their quadratures satisfy the uncertainty principle S̅_{qq}ⁱS̅ₚₚ¹≥¼ for each mode i={0, G}. Thus, Eq. (20) reduces to

$${\overline{S}}_{q q}^{o u t} {\overline{S}}_{p p}^{o u t} \geq {\vert {H}_{0} {H}_{G} \vert}^{2} = {\vert {H}_{0} \vert}^{2} ( {\vert {H}_{0} \vert}^{2} - 1 ) . \qquad ( 21 )$$

This is a state-independent constraint on the fluctuations in the output field of a feedback oscillator formed by positive feedback of a phase-insensitive amplifier in the absence of quantum correlations between its in-coupled and ancillary modes.

Eq. (21) is a form of a standard quantum limit (SQL) for the output of a feedback oscillator (“standard” here meaning a setting where no additional quantum strategies are employed). Around the carrier, where |H₀|>>1, so Eq. 21) is much tighter than the Heisenberg uncertainty principle in in Eq. (18). Indeed, the Schawlow-Townes limit is an instance of Eq. (21). To wit, for frequencies near the carrier, |H₀|>>1, so Eq. (21) implies S̅_{qq}^{out}S̅ₚₚ^{out}≳|H₀|⁴. The Schawlow-Townes limit is the case where this inequality is saturated by an equal partitioning of fluctuations between the two output quadratures, i.e., S̅_{qq}^{out,ST}≈S̅ₚₚ^{out,ST}≈|H₀|².Thus, for a feedback oscillator with a linear amplifier and linear output coupler, as long as the modes â₀ and â_{G} are independent, and the amplifier is phase-insensitive, any attempt to reduce frequency fluctuations below the Schawlow-Townes limit—by engineering the out-coupler or ancillary states—should elicit increased fluctuations in the output power of the oscillator. These assumptions can be relaxed to evade the SQL with varying degrees of malleability.

### Phase-Insensitive In-Loop Amplifier: Squeezing and Entanglement

The bound in Eq. (20) can be weakened by correlating the modes â₀ and â_{G} . To explicate this, we focus on the quadrature fluctuations near the carrier by expressing Eq. (14) at the offset frequency Ω₀+ω

$$\begin{matrix}{\hat{q}}_{out} [ ω ] \approx {H}_{0} [ ω ] ( {\hat{q}}_{0} [ ω ] - {\hat{q}}_{G} [ ω ] \\ {\hat{p}}_{out} [ ω ] \approx {H}_{0} [ ω ] ( {\hat{p}}_{0} [ ω ] + {\hat{p}}_{G} [ ω ]\end{matrix} . \qquad ( 22 )$$

For brevity, here and henceforth, we write ω in lieu of Ω₀+ω. Then the spectrum of the output phase and amplitude quadratures assumes the general form

$$\begin{matrix}{\overline{S}}_{q q}^{o u t} [ ω ] = {\vert {H}_{0} [ ω ] \vert}^{2} ( {\overline{S}}_{q q}^{0} [ ω ] + {\overline{S}}_{q q}^{G} [ ω ] - 2 Re [ {\overline{S}}_{q q}^{0 , G} [ ω ] ] ) \\ {\overline{S}}_{p p}^{o u t} [ ω ] = {\vert {H}_{0} [ ω ] \vert}^{2} ( {\overline{S}}_{p p}^{0} [ ω ] + {\overline{S}}_{p p}^{G} [ ω ] + 2 Re [ {\overline{S}}_{p p}^{0 , G} [ ω ] ] )\end{matrix} . \qquad ( 23 )$$

Squeezing either the in-coupled or ancillary mode can reduce the noise power in a desired quadrature. Entangling these modes—resulting in non-zero S̅_{qq}^{-0,G} and S̅ₚₚ^{-0,G}—can reduce fluctuations in both quadratures simultaneously. For illustration, imagine frequency-independent single-mode squeezing of the in-coupled mode â₀ and the amplifier's ancillary mode â_{G}, with squeezing parameters r₀ and r_{G} respectively, followed by two-mode squeezing of the modes with âₒ and â_{G} with squeezing parameter r_{E}. (The latter corresponds to continuous-variable EPR entanglement of the two modes âₒ and â_{G} Gaussian state techniques allow the resulting output spectra to be derived:

$$\begin{matrix}{\overline{S}}_{qq}^{out} [ ω ] = \frac{1}{2} {e}^{- {r}_{E}} ( {e}^{2 {r}_{0}} + {e}^{2 {r}_{G}} ) {\overline{S}}_{q q}^{out , ST} [ ω ] \\ {\overline{S}}_{pp}^{out} [ ω ] = \frac{1}{2} {e}^{- {r}_{E}} ( {e}^{- 2 {r}_{0}} + {e}^{- 2 {r}_{G}} ) {\overline{S}}_{p p}^{out , ST} [ ω ] .\end{matrix} \qquad ( 24 )$$

Squeezing the feedback oscillator's phase-quadratures, corresponding to r₀, r_{G}>0, suppresses the feedback oscillator's phase quadrature fluctuations-and therefore the linewidth of the feedback oscillator—below the Schawlow-Townes limit without bound, at the expense of increasing the feedback oscillator's amplitude quadrature fluctuations. Correlating these modes, corresponding to r_{E}>0, can simultaneously reduce the oscillator's amplitude and phase quadrature fluctuations below the Schawlow-Townes limit. However, the Heisenberg uncertainty relation [Eq. (18)] S̅_{qq}^{-out}S̅ₚₚ^{-out}≥¼ still holds and represents the limit to which noise in the output quadratures of a feedback oscillator can be suppressed simultaneously.

These results show that feedback oscillators featuring sub-Schawlow-Townes phase noise performance are possible with linear (phase-insensitive) amplifiers and linear out-couplers, but with the injection of squeezed or entangled states into the feedback loop.

### Phase-Sensitive In-Loop Amplifier

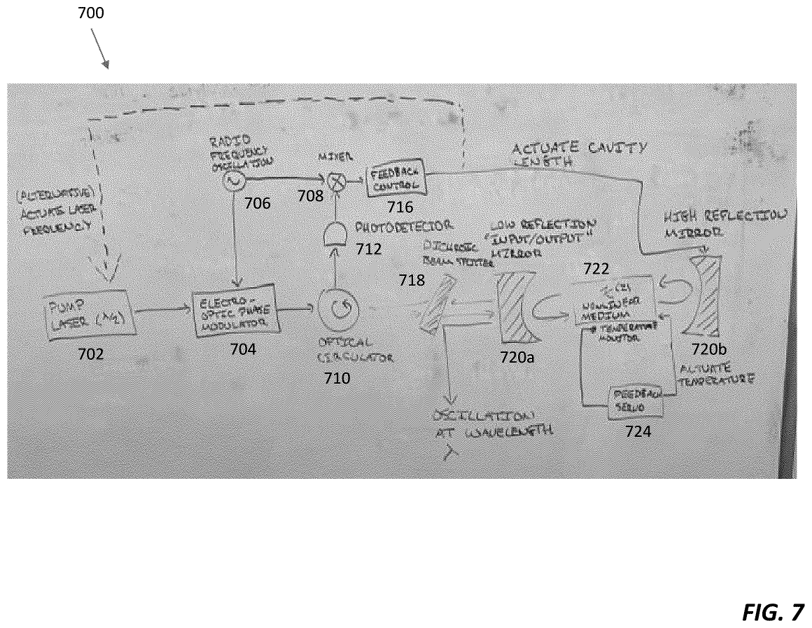

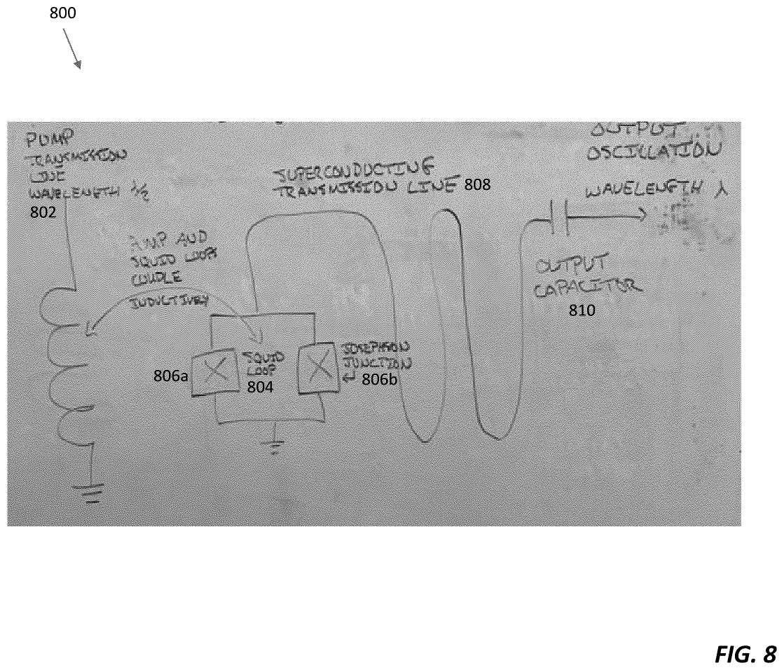

An alternative method of reducing a feedback oscillator's output amplitude and phase spectra is to modify the feedback loop itself by replacing the phase-insensitive amplifier by a phase-sensitive amplifier as depicted in FIG. 1B. FIG. 1B shows a general phase-sensitive amplifier decomposed into a phase-insensitive amplifier followed by an ideal (i.e., noiseless) phase-sensitive amplifier with squeezing parameter ζ=rₛ^{iφ}^{ₛ}. When the phase-insensitive component has unity-gain, this cascade realizes a noiseless phase-sensitive amplifier. Such a feedback oscillator can be implemented as an optical parameter oscillator (OPO) with a second-order nonlinear χ⁽²⁾ medium in a laser cavity or a Josephson parametric oscillator (JPO) as shown at lower left and right, respectively, of FIG. 1B and explained in greater detail below with respect to FIGS. 7 and 8, respectively.

As before, the nonlinear saturating response of the phase-insensitive amplifier limits the feedback oscillator's output; an extension of the prior analysis shows that this happens when Ge^{r}^{ₛ}\sqrt{η}=1, which can be interpreted as a balance between the phase-sensitive gain (Ge^{r}^{ₛ}) and loss in the loop. Linear response around this steady-state oscillation is described by

$$\begin{matrix}{\hat{a}}_{out}^{-} [ Ω ] & = & cosh ( {r}_{s} ) {\hat{a}}_{s} [ Ω ] + {e}^{i {φ}_{s}} sinh ( {r}_{s} ) {\hat{a}}_{s}^{†} [ Ω ] \\ {\hat{a}}_{s} [ Ω ] & = & G {\hat{a}}_{i n} [ Ω ] + \sqrt{{G}^{2} - 1} {\hat{a}}_{G}^{†} [ Ω ]\end{matrix} \qquad ( 25 )$$

to replace the response of the in-loop amplifier in the phase-insensitive case [Eq. (9)]. Here, as above, â₀ and â_{G} are the modes conveying noise at the out-coupler and the in-loop amplifier. The full set of loop equations can be solved as before, and imposition of canonical commutation relations on the in-coupled and out-going fields implies that the ancillary mode â_{G} obeys them. In the extreme case where the in-loop amplifier is purely phase-sensitive (G=1 in Eq. (25)), i.e., a single mode squeezer with no additional noise, the output quadrature spectra are

$$\begin{matrix}{\overline{S}}_{q q}^{out} [ Ω ] & = & ( 1 + \frac{{( \sqrt{η} - 1 / \sqrt{η} )}^{2}}{4 {cos}^{2} ( Ωτ / 2 )} ) {\overline{S}}_{q q}^{0} [ ω ] \\ {\overline{S}}_{pp}^{out} [ Ω ] & = & ( \frac{4 {cos}^{2} ( Ωτ / 2 )}{{( \sqrt{η} - 1 / \sqrt{η} )}^{2} + 4 {cos}^{2} ( Ωτ / 2 )} ) {\overline{S}}_{pp}^{0} [ ω ]\end{matrix} . \qquad ( 26 )$$

Since Ŝ_{qq}^{-out}Ŝₚₚ^{-out}=Ŝ_{qq}⁻⁰Ŝₚₚ⁻⁰,the feedback oscillator does not increase the uncertainty product between the amplitude and phase quadratures from its input to output. In particular, if the in-coupled field âₒ is vacuum, the oscillator's output field is a minimal uncertainty squeezed state around the steady-state oscillating carrier—a bright squeezed state.

In practice, technical phase noise and pump noise in the squeezer may contaminate its output, precluding the zero phase noise around the carrier predicted by Eq. (26). The predictions of Eq. (26), based on a model of a phase-sensitive amplifier in a feedback loop, are consistent with a Hamiltonian model of an optical parametric oscillator (OPO); the latter elucidates the origin of phase-sensitive amplifier saturation and the conditions for reducing or minimizing the effects of pump noise.

### Comparing Squeezing, Squeezing and Entanglement, and Phase Sensitivity

FIG. 3 compares the output phase quadrature spectra of a feedback oscillator with a phase-insensitive amplifier and squeezed in-coupled and ancillary modes (upper middle trace), a feedback oscillator with a phase-insensitive amplifier and squeezed and entangled in-coupled and ancillary modes (lower middle trace), and a feedback oscillator with a phase-sensitive amplifier (bottom trace). The top trace in FIG. 3 is the Schalow-Townes spectrum of a feedback oscillator with a phase-sensitive amplifier and in-coupled and ancillary modes in vacuum. The horizontal line is at Sₚₚ^{-out}=½.

As can be seen in FIG. 3, embedding a phase-sensitive amplifier in the feedback loop suppresses the oscillator's phase-quadrature spectrum much more than is possible by squeezing or correlating the input modes for a given maximal level of squeezing. Unlike squeezing the in-coupled and ancillary modes, entangling these modes or embedding a phase-sensitive amplifier in the feedback loop reduces the oscillator's output phase noise without increasing amplitude noise.

### Spectral Densities and Their Uncertainty Principle

The Fourier transform of a time-dependent (though not necessarily Hermitian) operator Â(t) can be defined as

$$\hat{A} [ Ω ] = {\int }_{ℝ} \hat{A} ( t ) {e}^{i Ω t} dt , \qquad ( 27 )$$

where Ω∈ [symbol] . The Fourier transform of the Hermitian conjugate, denoted by Â^{†}[Ω], is different from the Hermitian conjugate of the Fourier transform, represented by Â[Ω]^{†}; the two are related as

$${\hat{A}}^{†} [ Ω ] = {\hat{A} [ - Ω ]}^{†} . \qquad ( 28 )$$

If Â is Hermitian, i.e., Â(t)^{†}=Â(t), then

$${\hat{A}}^{†} [ Ω ] = \hat{A} [ Ω ] . \qquad ( 29 )$$

The inverse of Eq. (27) is given by

$$\hat{A} ( t ) = {\int }_{ℝ} \hat{A} [ Ω ] {e}^{- i Ω t} \frac{d Ω}{2 π} . \qquad ( 30 )$$

We define the cross-correlation between the two general (not necessarily Hermitian and not necessarily commuting) operators Â, \hat{B} by the symmetrized expression,

$${\overline{S}}_{A B} ( t ) = \frac{1}{2} 〈 \{ {\hat{A}}^{†} ( t ) , \hat{B} ( 0 ) \} 〉 .$$

We use the symmetrized double-sided cross-correlation spectrum, defined as the Fourier transform of the symmetrized cross-correlation:

$$\begin{matrix}{\overline{S}}_{A B} [ Ω ] = {\int }_{- ∞}^{∞} \frac{1}{2} 〈 \{ {\hat{A}}^{†} ( t ) , \hat{B} ( 0 ) \} 〉 {e}^{i Ω t} d t \\ = {\int }_{- ∞}^{∞} \frac{1}{2} 〈 \{ {\hat{A}}^{†} [ Ω ] , \hat{B} [ {Ω}^{′} ] \} 〉 \frac{d {Ω}^{′}}{2 π}\end{matrix} , \qquad ( 31 )$$

where the last equality follows from using the Fourier representation [Eq. (30)] of the time-dependent operators.

For weak-stationary operators, i.e., those that pair-wise satisfy [symbol] Â(t), \hat{B}(t′) [symbol] = [symbol] Â(t−\hat{t}), \hat{B}(0) [symbol] , the spectrum is given by the identity,

$${\overline{S}}_{A B} [ Ω ] \cdot 2 πδ [ Ω + {Ω}^{′} ] = \frac{1}{2} 〈 \{ {\hat{A}}^{†} [ Ω ] , \hat{B} [ {Ω}^{′} ] \} 〉 . \qquad ( 32 )$$

In this case, S̅_{AB}[Ω]*=S̅_{BS}[Ω].
Lemma 1. The spectrum of a weak-stationary (but not necessarily Hermitian) operator is positive, i.e.,

$${\overline{S}}_{A A} [ Ω ] \geq 0 , if 〈 {\hat{A}}^{†} ( t ) \hat{A} ( {t}^{′} ) 〉 = 〈 {\hat{A}}^{†} ( t - {t}^{′} ) \hat{A} ( 0 ) 〉 . \qquad ( 33 )$$

Proof. Since Â is weak-stationary, Eq. (32), together with Eq. (28), implies that

$${\overline{S}}_{A A} [ Ω ] \cdot 2 πδ [ 0 ] = \frac{1}{2} 〈 \{ {\hat{A} [ - Ω ]}^{†} , \hat{A} [ - Ω ] \} 〉 .$$

Next, we show that the right-hand side is positive. Consider the first term, which is the expectation of the Hermitian operator, Â[−Ω]^{†}Â[−Ω] over some state, say \hat{p}. Since the general state \hat{p} can be expressed as a convex combination, \hat{p}=Σᵢpᵢ|Ψᵢ [symbol] [symbol] Ψᵢ|, with pᵢ≥0, Σᵢpᵢ=1, and [symbol] Ψᵢ|Ψⱼ [symbol] =δᵢⱼ, the expectation value may be written as,

$$\begin{matrix}〈 {\hat{A} [ - Ω ]}^{†} \hat{A} [ - Ω ] 〉 = Tr [ {\hat{A} [ - Ω ]}^{†} \hat{A} [ - Ω ] \hat{ρ} ] \\ = {\sum }_{i} {p}_{i} 〈 {ψ}_{i} \vert {\hat{A} [ - Ω ]}^{†} \hat{A} [ - Ω ] \vert {ψ}_{i} 〉 \\ {= {\sum }_{i} {p}_{i} ‖ \hat{A} [ - Ω ] \vert {ψ}_{i} 〉 ‖}^{2} \geq 0\end{matrix} ,$$

The same argument applies to the second term.

Theorem 1 (Uncertainty principle for spectra). For weak-stationary Hermitian operators Â and \hat{B} that satisfy the commutation relationship [Â[Ω], \hat{B}[Ω′]]=ic·2πδ[Ω+Ω′] for some real constant c,

$${\overline{S}}_{A A} [ Ω ] {\overline{S}}_{B B} [ Ω ] \geq \frac{{c}^{2}}{4} + {\vert {\overline{S}}_{A B} [ Ω ] \vert}^{2} . \qquad ( 34 )$$

Proof. Let {Â} be a set of weak-stationary observables; then their linear combination, \hat{M}=ΣⱼaⱼÂⱼ with aⱼ∈ [symbol] is also weak-stationary. Using the fact that [symbol] \hat{M}[−Ω]^{†}\hat{M}[−Ω] [symbol] ≥0 as shown in the proof of Lemma 1, we have

$${\sum }_{j , k} {α}_{j}^{*} {α}_{k} 〈 {\hat{A}}_{j} [ Ω ] {\hat{A}}_{k} [ - Ω ] 〉 \geq 0 ,$$

where we have used Eq. (29). Splitting Âⱼ[Ω]Âₖ[−Ω] into Hermitian and anti-Hermitian parts

$${\hat{A}}_{j} [ Ω ] {\hat{A}}_{k} [ - Ω ] = \frac{1}{2} \{ {\hat{A}}_{j} [ Ω ] , {\hat{A}}_{k} [ - Ω ] \} + \frac{1}{2} [ {\hat{A}}_{j} [ Ω ] , {\hat{A}}_{k} [ - Ω ] ] ,$$

the above inequality becomes

$${\sum }_{j , k} {α}_{j}^{*} {α}_{k} ( {\overline{S}}_{{A}_{j} {A}_{k}} [ Ω ] + {\overline{C}}_{{A}_{j} {A}_{k}} [ Ω ] ) \geq 0 , \qquad ( 35 )$$

$$where$$

$${\overline{C}}_{A B} [ Ω ] ≡ {\int }_{- ∞}^{∞} \frac{1}{2} [ {\hat{A}}^{†} [ Ω ] , {\hat{B} [ Ω ]}^{′} ] 〉 \frac{d {Ω}^{′}}{2 π} .$$

Since the inequality in Eq. (35) is true for arbitrary aⱼ, the eigenvalues of the matrix with elements S̅_{AjA}_{ₖ}[Ω]+C̅_{Aj,A}_{ₖ}[Ω] is non-negative. Specifically, the smallest eigenvalue of this matrix is non-negative.

Consider now the case where {Âⱼ}={Â, \hat{B}} with [Â[Ω], \hat{B}[Ω′]]=ic·2πδ[Ω+Ω′]. Per Eq. (35),

$${\overline{S}}_{A A} {\overline{S}}_{B B} - ( {\overline{S}}_{A B} + {\overline{C}}_{A B} ) ( {\overline{S}}_{B A} + {\overline{C}}_{B A} ) \geq 0 .$$

Simplifying using the fact that C̅_{AB}[Ω]=C̅_{BA}*[Ω]=ic/2 and S̅_{AB}[Ω]=Ŝ_{BA}*[Ω], gives Eq. (34).

### Saturating Behavior of Phase-Insensitive Feedback Oscillators and Classical Steady State

Here, we analyze the classical steady-state behavior of the saturating feedback oscillator shown in FIG. 1A. Classically, the behavior of the system shown in FIG. 1A is governed in the time domain by

$$\begin{matrix}{α}_{out}^{-} ( t ) & = & 𝒜 [ {α}_{i n} ( t ) ] \\ {α}_{out}^{+} ( t ) & = & - \sqrt{η} {α}_{out}^{-} ( t ) + \sqrt{1 - η} {α}_{0} ( t ) \\ {α}_{out} ( t ) & = & \sqrt{1 - η} {α}_{out}^{-} ( t ) + \sqrt{η} {α}_{0} ( t ) \\ {α}_{i n} ( t ) & = & {α}_{out}^{+} ( t - τ )\end{matrix} . \qquad ( 36 )$$

where {aᵢ} are classical field amplitudes and [symbol] [⋅] is the amplifier's nonlinear response. Eq. (36) can be simplified to

$${α}_{out}^{+} ( t ) = - \sqrt{η} 𝒜 [ {α}_{out}^{+} ( t - τ ) ] + \sqrt{1 - η} {α}_{0} ( t - τ ) . \qquad ( 37 )$$

The input a₀(t) sources the classical field that circulates in the loop. In reality, the input represented by a₀ is pure noise; in the ideal case, just vacuum noise.

To analyze how the feedback loop attains a steady state when driven purely by noise, assume that a₀ represents infinitesimally small fluctuations. To understand how the loop starts, consider that a₀ (0) is a small random value and zero for t>0. Let this produce a small amplitude aₒᵤₜ^{†}(0<t<τ)=δ. We are primarily interested in the circulating power rather than phase rotations, so taking the magnitude square of Eq. (37) under these conditions:

$$\begin{matrix}{\vert {α}_{out}^{+} ( t ) \vert}^{2} & = & η {\vert 𝒜 [ {α}_{out}^{+} ( t - τ ) ] \vert}^{2} \\ {α}_{out}^{+} ( 0 < t < τ ) & = & δ\end{matrix} . \qquad ( 38 )$$

That is, if the initial random seed a₀ (0) produces a steady state amplitude, it should satisfy

$$\vert 𝒜 [ {α}_{out}^{+} ] \vert = {α}_{out}^{+} / \sqrt{η} , \qquad ( 39 )$$

which defines the steady state aₛₛ of Eq. (7).

The above is only a necessary condition since the question of the stability of this steady state remains open. We now show that the four properties of [symbol] listed above suffice to ensure stability. Properties (1), (3), and (4) imply that

$${𝒜}^{′} ( x ) = \frac{d 𝒜}{d x} < \frac{𝒜 ( x )}{χ} ∀ x .$$

Let aₒᵤₜ^{†}(t)=aₛₛ+δₜ where δₜ is a small perturbation to the steady state value of aₒᵤₜ^{†}at time t. Similarly, let aₒᵤₜ^{†}(t+τ=aₛₛ+δ_{τ}then reads |aₛₛ+δ_{τ}|²=η| [symbol] [aₛₛ+δₜ]|². Expanding to first order in δₜ, δ_{τ}and using Eq. (39) gives

$$\vert {δ}_{τ} \vert = \frac{{α}_{s s} {𝒜}^{′} [ {α}_{s s} ]}{𝒜 [ {α}_{s s} ]} \vert {δ}_{t} \vert ⇒ \vert {δ}_{τ} \vert < \vert {δ}_{t} \vert \qquad ( 40 )$$

where we have used the properties of [symbol] . Thus, perturbations around the steady state tend to die over time; i.e., the steady state is stable to small perturbations.

Similarly, we can show that the operating point where all amplitudes are zero is unstable. That is, any initial fluctuation should drive the loop to its steady state Eq. (39). Now, let aₒᵤₜ^{†}(t)=δₜ and let aₒᵤₜ^{†}(t+τ)=δ_{τ}where δ_{τ}and δₜ are sufficiently small that property (3) is satisfied. We have

$${\vert {δ}_{τ} \vert}^{2} = η {\vert 𝒜 [ {δ}_{t} ] \vert}^{2} ⇒ \vert {δ}_{τ} \vert = \sqrt{η} \vert {G}_{0} \vert \vert {δ}_{t} \vert ⇒ \vert {δ}_{τ} \vert > \vert {δ}_{t} \vert . \qquad ( 41 )$$

Here G₀= [symbol] [0], the linear slope of the amplifier's nonlinear response around zero.

In sum, the feedback loop of a feedback oscillator should reach a steady state with a large circulating classical field with amplitude as and a linearized gain of

$$G ≡ {lim}_{t \to + ∞} \frac{{α}_{out}^{-} ( t )}{{α}_{i n} ( t )} = \frac{𝒜 [ {α}_{s s} ]}{{α}_{s s}} = \frac{1}{\sqrt{η}} . \qquad ( 42 )$$

We emphasize two points of this classical analysis of saturating feedback oscillators. First, any small initial fluctuation should be amplified, eventually reaching a stable equilibrium with a large-amplitude output field aₛₛ circulating in the loop. This oscillating field is a fundamental feature of a positive feedback oscillator. Second, at this equilibrium point, the gain medium is linear for small perturbations around the large field, with a gain given by the requirement for the system to conserve round-trip power in steady state, i.e., G=/\sqrt{η}. The fact that any amplifier satisfying properties (1) through (4) embedded in a feedback loop saturates to a point where it can be treated as having a linear gain allows for a linear quantum mechanical analysis of the oscillator's phase and amplitude fluctuations.

### Linear Response of Phase-Insensitive Feedback Oscillators

Consider the positive feedback amplifier configuration shown in FIG. 1A. The output of a phase-insensitive amplifier with gain G is coupled back into its input after attenuation by a factor \sqrt{η} and a delay of τ. The remaining fraction of the signal is coupled out of the loop to derive the out-of-loop field aₒᵤₜ.

The equations of motion for the system are obtained by going around the feedback loop in FIG. 1A. For the Heisenberg-picture operators in the time domain, we have

$$\begin{matrix}{\hat{a}}_{out}^{-} ( t ) & = & G {\hat{a}}_{i n} ( t ) + \sqrt{{G}^{2} - 1} {\hat{a}}_{G}^{†} ( t ) \\ {\hat{a}}_{out}^{+} ( t ) & = & - \sqrt{η} {\hat{a}}_{out}^{-} ( t ) + \sqrt{1 - η} {\hat{a}}_{0} ( t ) \\ {\hat{a}}_{out} ( t ) & = & \sqrt{1 - η} {\hat{a}}_{out}^{-} ( t ) + \sqrt{η} {\hat{a}}_{0} ( t ) \\ {\hat{a}}_{i n} ( t ) & = & {\hat{a}}_{out}^{+} ( t - τ )\end{matrix} . \qquad ( 43 )$$

The ancillary mode â_{G} describes the unavoidable noise added in any phase-insensitive linear amplifier.

Eq. (43) can be solved in the frequency domain for the output field âₒᵤₜ[Ω] in terms of the inputs â₀[Ω] and â_{G}[Ω]. The result is

$$\begin{matrix}{\hat{a}}_{out} [ Ω ] = \frac{\sqrt{η} + G {e}^{i Ω τ}}{1 + G \sqrt{η} {e}^{i Ω τ}} {\hat{a}}_{0} [ Ω ] + \frac{\sqrt{{G}^{2} - 1} \sqrt{1 - η}}{1 + G \sqrt{η} {e}^{i Ω τ}} {\hat{a}}_{G}^{†} [ Ω ] \\ ≡ {H}_{0} [ Ω ] {\hat{a}}_{0} [ Ω ] + {H}_{G} [ Ω ] {\hat{a}}_{G}^{†} [ Ω ]\end{matrix} , \qquad ( 44 )$$

where H_{0,G} are the corresponding linear response transfer functions. In steady state, G=1/\sqrt{η}, so the feedback path is characterized by two quantities, the beam-splitter transmissivity n and the delay τ, so

$${H}_{0} [ Ω ] = \frac{\sqrt{η} + \frac{1}{\sqrt{η}} {e}^{i Ω τ}}{1 + {e}^{i Ω τ}} , {H}_{G} [ Ω ] = \frac{1 / \sqrt{η} - \sqrt{η}}{1 + {e}^{i Ω τ}} . \qquad ( 45 )$$

### Decomposing a Phase-Sensitive Amplifier as a Phase-Insensitive Amplifier and a Squeezer

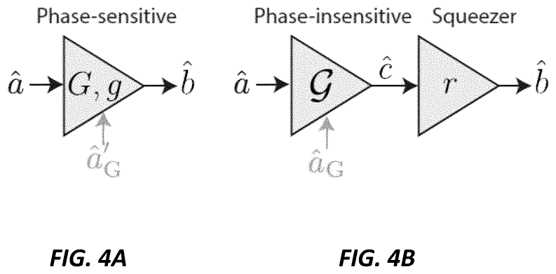

FIGS. 4A and 4B illustrate how a quantum-limited phase-sensitive amplifier (G, g) (FIG. 4A) can be decomposed into an ideal phase-insensitive amplifier (G) followed by an ideal single-mode squeezer (r) (FIG. 4B). The phase-sensitive amplifier in FIG. 4A amplifies an input â to produce the output \hat{b}=Gâ+gâ^{†}+â_{G}^{†}, where â_{G} is the amplifier's ancillary mode. (The ancillary mode, â_{G}, does not necessarily have bosonic statistics here.) The phase-sensitive amplifier in FIG. 4A is equivalent to an ideal phase-insensitive amplifier with gain [symbol] =\sqrt{G²−g²} that sends mode â to the mode c= [symbol] a+â_{G}′^{†}, followed by an ideal squeezer which sends the mode ĉ to the output mode \hat{b}=cosh(r)ĉ+sinh(r)ĉ⁺with tanh(r)=g/G (see FIG. 4B).

For this equivalence to hold, â_{G}^{†}=(Ga_{G}⁺+gâ_{G}′)/ [symbol] which can be shown by explicit computation.

In the case of the phase-sensitive amplifier, the output mode \hat{b} is given in terms of the input mode â by \hat{b}=Gâ+gâ^{†}+ga⁺+a_{G}^{t}. In the case of a phase-insensitive amplifier followed by a squeezer (assuming G and g are positive), the output mode is

$$\begin{matrix}\hat{b} = cosh ( r ) \hat{c} + sinh ( r ) {\hat{c}}^{†} \\ = cosh ( r ) ( 𝒢 \hat{a} + {\hat{a}}_{G}^{′†} ) + sinh ( r ) ( 𝒢 {\hat{a}}^{†} + {\hat{a}}_{G}^{′} ) \\ = G \hat{a} + g {\hat{a}}^{†} + \frac{G {\hat{a}}_{G}^{′†} + {gâ}_{G}^{′}}{\sqrt{{G}^{2} - {g}^{2}}} \\ ≡ Gâ + g {\hat{a}}^{†} + {\hat{a}}_{G}^{†}\end{matrix} , \qquad ( 46 )$$

Additionally, â_{G} and a_{G}′ have the same commutation relations.

$$\begin{matrix}[ {a}_{G} , {a}_{G}^{†} ] = \frac{[ G {a}_{G}^{′} + g {a}_{G}^{′†} , {Ga}_{G}^{′†} + g {a}_{G}^{′} ]}{{G}^{2} - {g}^{2}} \\ = \frac{{G}^{2} [ {a}_{G}^{′} , {a}_{G}^{′†} ] + {g}^{2} [ {a}_{G}^{′†} , {a}_{G}^{′} ]}{{G}^{2} - {g}^{2}} \\ = [ {a}_{G}^{′} , {a}_{G}^{′†} ]\end{matrix} , \qquad ( 47 )$$

so this decomposition of a phase-sensitive amplifier is correct.

One benefit of this decomposition is that it clarifies the extent to which a phase-sensitive amplifier should add noise: the phase-insensitive component in its decomposition adds noise, while the squeezer is noiseless.

### Examples of Quantum-Noise-Limited Feedback Oscillators

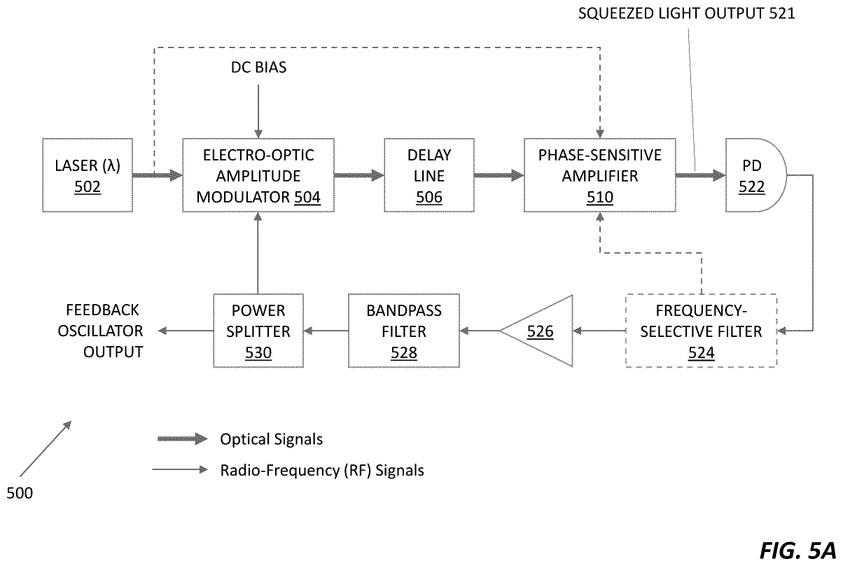

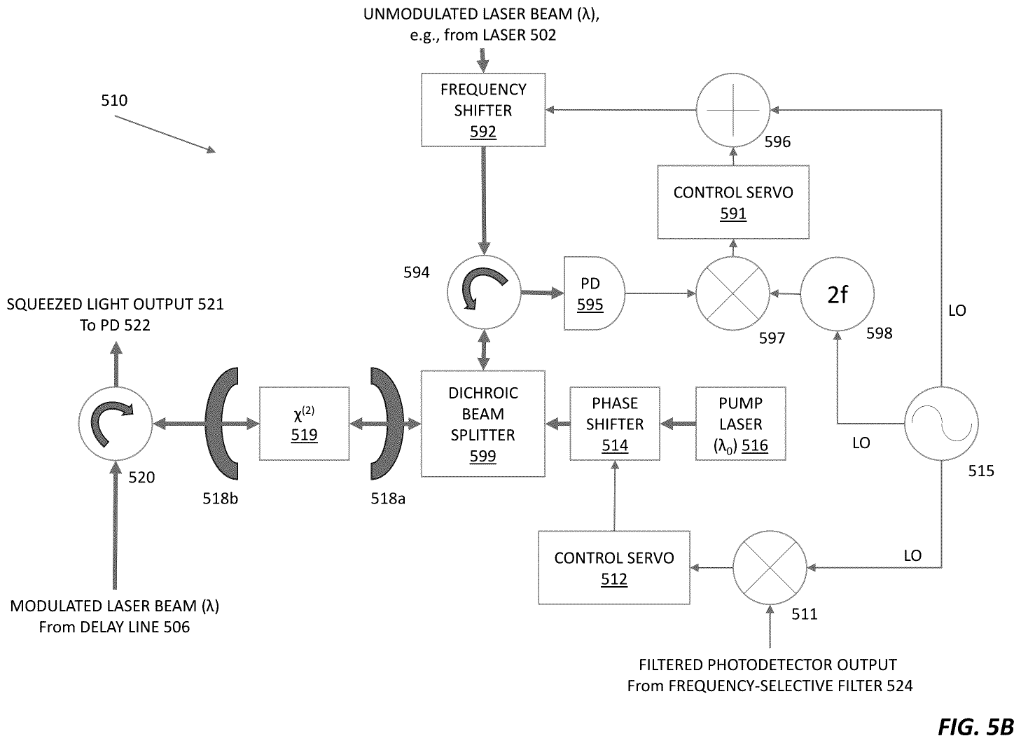

FIG. 5A illustrates a quantum-noise-limited optoelectronic oscillator (OEO) 500 that produces a radio-frequency (RF) output that is more stable than the Schalow-Townes limit thanks to a phase-sensitive amplifier 510. The OEO 500 includes a laser 502 that emits coherent radiation in the form of a laser beam at a wavelength δ. An electro-optic amplitude modulator 504, such as a Mach-Zehnder modulator biased at quadrature so that its response is linear and symmetric, coupled to the output of the laser 502 modulates the amplitude of the laser beam, e.g., at a rate of 1 MHz to 10 GHz.

An optical delay line 506 delays the amplitude-modulated laser beam, which is then amplified by the phase-sensitive amplifier 510 to produce a squeezed light output 521, which is detected by a photodetector 522. The length of the optical delay line 506 sets the OEO's resonance frequency. For instance, for the OEO 500 to resonate the fundamental mode at 10 MHz, the optical delay line should be about 30 meters long, assuming its index of refraction is near unity. More generally, the time delay is determined by the delay line's index of refraction and length. The optical delay line 506 can be tunable (e.g., it can be a length of optical fiber delay wrapped around a piezo-electric fiber stretcher) to produce an output beam with a tunable frequency. The optical delay line 506 should be sufficiently stabilized such that the OEO's output frequency stability is not limited by fluctuations in the time delay caused by the optical delay line 506. This stabilization can be done passively (for instance, by seismic and acoustic isolation) or actively by serving the optical delay line's length to match the length of a reference cavity or a stabilized reference delay line.

The photodetector 522 emits an electronic-domain, RF signal whose amplitude is proportional to the intensity of the squeezed light output 521 and dominated by shot noise generated by detecting the squeezed light output 521. An optional frequency-selective filter 524 coupled to the output of the photodetector 522 filters the RF signal and optionally directs a portion of the filtered RF signal back to the phase-sensitive filter 510 as described in greater detail below with respect to FIG. 5B. The frequency-selective filter 524 can be implemented as a dichroic filter that splits the incident signal into two paths depending on their frequencies in order to pass (1) the RF oscillation to an RF amplifier 524 and back to the electro-optic amplitude modulator 504 and (2) a signal used to control the phase-sensitive amplifier's phase to the phase-sensitive amplifier 510. The RF amplifier 526 amplifies the (rest of the) filtered RF signal, which is filtered with a bandpass filter 528 before being split by a power splitter 530 into two portions, with one portion driving the electro-active amplitude modulator 504 and closing the feedback loop. The other portion of the power splitter's output is emitted as the phase-stabilized output of the OEO 500.

FIG. 5B illustrates a phase-sensitive optical parametric amplifier (OPA) implementation of the phase-sensitive amplifier 510 in FIG. 5A. In operation, the OPA 510 amplifies and squeezes the modulated laser beam from the delay line 506 based on the (optionally filtered) output of the photodetector 522. This squeezed beam is generated by a parametric interaction between the modulated laser beam, an unmodulated laser beam with an offset frequency from the modulated laser's wavelength, and a pump beam from a pump laser 516 that is phase-shifted by an error signal generated from the output of the photodetector 522.

The OPA 510 generates the error signal from the output of the photodetector 522 with a mixer 511 that mixes the (filtered) output of the photodetector 522 or optional frequency-selective filter 524 with a local oscillator (LO) from a stable RF synthesizer 515. The LO frequency should be within the OPA's linewidth, but at a large enough frequency separation from the OEO's resonant frequency that it doesn't interfere with the rest of the OEO's operation. The mixer's output is the error signal, which controls a phase shifter 514 that actuates the phase of the pump beam at a wavelength δ₀. The error signal stabilizes the phase relationship between the modulated laser beam and the OPA's pump beam. Put differently, the mixer 511 controls the squeezing angle of the phase-sensitive OPA 510. Generally, the squeezing angle should be chosen to provide a stable, well-defined phase for the squeezed light output 521.

A dichroic beam splitter 599 couples the phase-shifted pump beam into a cavity that is formed by partially transmissive mirrors 518a and 518b and contains a second-order nonlinear medium 519 (e.g., a KDP, KTP, BBO, or LiNbO₃ crystal). The dichroic beam splitter 599 also couples an unmodulated laser beam at the same wavelength as the modulated laser beam into the cavity. This unmodulated laser beam and the pump beam are both phase-locked to the cavity.

The unmodulated laser beam can be picked off from the laser 502 in FIG. 5A or emitted by a separate laser that is phase-locked to the laser 502. A frequency shifter 592 shifts the frequency of the unmodulated laser beam by the sum of the LO frequency and a correction that keeps the unmodulated laser beam phase-locked to the cavity. To phase-lock the unmodulated laser beam to the cavity, the beam reflected from the cavity is coupled to a photodetector 595 with a circulator 594 that also couples the unmodulated laser beam to the cavity. The signal from this photodetector 595 is demodulated via a mixer 597 at twice the LO frequency. Here, the doubled LO frequency is created by sending the LO through a frequency doubler 598 driven by the stable RF synthesizer 515. The phase/frequency correction from the mixer 597 is sent to a control servo 591 and summed with the LO frequency via a frequency adder 596. This signal containing the LO frequency and a correction that keeps the unmodulated laser beam phase-locked to the cavity is then sent to a frequency shifter 593 that modulates the frequency of the unmodulated laser beam.

As mentioned above, the dichroic beam splitter 599 combines the phase-locked, unmodulated laser beam with the pump laser beam. The squeezed light output 521 contains a bright squeezed field with RF sidebands at the OEO's resonant frequency and sidebands at the LO frequency from the phase-locked, unmodulated laser beam. The phase-locked, unmodulated laser beam reflected from the cavity includes sidebands but no carrier, so the photodetector 595 senses a beat note at twice the LO frequency (i.e., the interference of the upper and lower sidebands). At the same time, the photodetector 522 (FIG. 5A) in the OEO 500 detects the squeezed light output 521 and generates an RF signal that is split by the frequency selective filter 524, which sends the component of the RF signal near the LO frequency to a mixer 511. The mixer 511 mixes this signal with the LO, with the mixer's intermediate frequency output driving a control servo 512 that actuates a phase shifter 514, which phase-shifts the modulated laser beam from the delay line 506 (FIG. 5A). This ensures that the OPA 500 amplifies the amplitude quadrature (and not the phase quadrature) of the field incident on the photodetector 522.

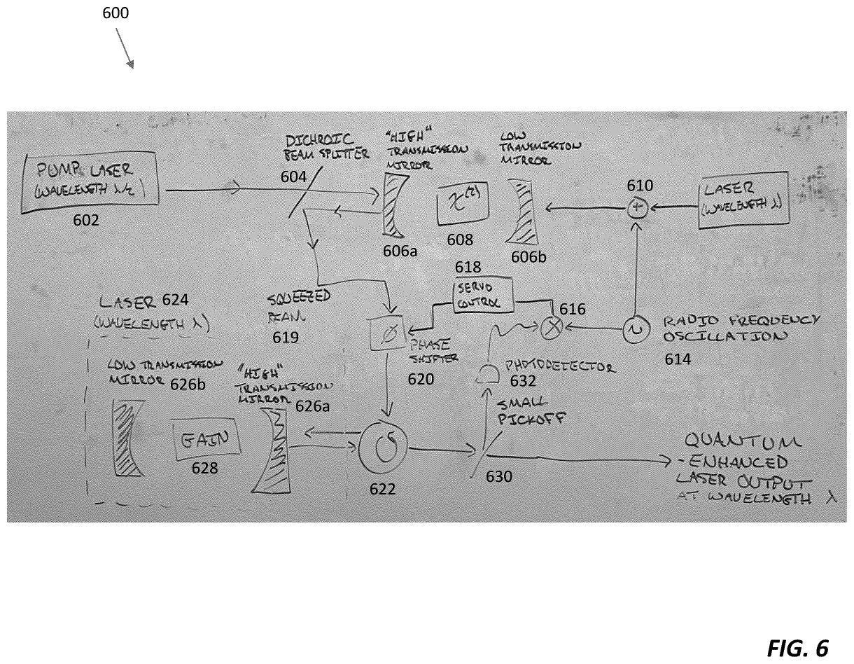

FIG. 6 illustrates a quantum-noise-limited laser 600. Like a conventional laser, the quantum-noise-limited laser 600 includes a gain medium 628 in a laser cavity formed by a low-transmission mirror 628a and high-transmission mirror (output coupler) 628b. Unlike in a conventional laser, however, the gain medium 626 in the quantum-noise-limited laser 600 is pumped via the output coupler 628b with squeezed vacuum generated by an OPA like the one shown in FIG. 5B. This squeezed vacuum is a stable field whose phase quadrature is aligned with the phase quadrature of the laser output. Injecting the squeezed vacuum into the laser cavity manipulates the laser's quantum noise statistics and reduces quantum noise at the laser's output, which is at a wavelength δ.

The OPA in the quantum-noise-limited laser 600 includes a pump laser 602 that pumps a second-order nonlinear medium 608 in a cavity formed by high and low transmission mirrors 606a and 608b with a pump beam at a wavelength δ/2 via a dichroic beam splitter 604. In operation, the nonlinear cavity formed by the mirrors 606a and 606b and the second-order nonlinear medium 608 acts as a squeezer. The pump beam interacts with the second-order nonlinear medium 608 and the cavity to produce a squeezed beam 619.

The frequency-shifted copy of the laser output is just used to control the phase-angle of the squeezed beam 619. More specifically, the squeezed beam 619 is phase-stabilized with respect to the laser output using a mixer 616, servo control 618, phase shifter 620, frequency shifter 610, and photodetector 632. The photodetector 632 transduces a portion the laser output, picked off by a beam splitter 630, into an RF signal that is mixed with the LO by a mixer 616. The mixer produces an error signal that drives the servo control 618, which in turn controls a phase shifter 620 that modulates the phase of the squeezed field 619 that is injected into the laser cavity. A circulator 622 couples the squeezed field 619 into the laser cavity via the output coupler 626a and couples the laser output out of the laser.

FIG. 7 shows an optical parametric oscillator (OPO) 700 with a second-order nonlinear medium 722 that provides phase-sensitive amplification of the OPO's output, which is a stabilized optical beam at a wavelength δ. The OPO 700 includes a pump laser 702 that emits a pump beam at a wavelength δ/2 This pump beam is phase-modulated by an electro-optic phase modulator 704, which is driven by an RF oscillator 706 that also drives one input of a mixer 708. A circulator 710 couples the phase-modulated pump beam through a dichroic beam splitter 718 and into a cavity that is formed by reflectors 720a and 720b and contains the second-order nonlinear medium 722. Half-harmonic generation in the second-order nonlinear medium 722 acts as a squeezer by generating a squeezed half-harmonic beam at a wavelength δ. This squeezed half-harmonic beam is coupled out of the cavity through the output coupler 720a and out of the OPO by the dichroic beam splitter 718.

The output coupler 720a also releases a portion of the pump beam from the cavity for generating an error signal used to stabilize the phase relationship between the pump beam and the OPO's output in a Pound-Drever-Hall locking scheme. The dichroic beam splitter 718 transmits this portion of the pump beam to the circulator 710, which couples it to a photodetector 712. The photodetector 712 detects the released portion of the pump beam, generating an RF signal that the mixer 708 mixes with the same RF signal used to phase-modulate the pump beam.

Feedback control circuitry in the form of a feedback controller 716 and a feedback servo 724 stabilize the phase relationship between the pump beam and the OPO's output. The feedback controller 716 is driven by an error signal created by mixing the signal used to phase-modulate the pump beam with the mixer 708. The feedback controller 716 modulates the wavelength of the pump laser 702 and/or the length of the cavity (e.g., with an actuator that moves mirror 720b) to compensate for fluctuations in the relative phase between the pump beam and the OPO output (half harmonic). The feedback servo 724 stabilizes the temperature of the second-order nonlinear medium 722 (e.g., with a temperature monitor/heater).

FIG. 8 shows a quantum-noise-limited Josephson parametric oscillator (JPO) 800 with a superconducting quantum interference device (SQUID) loop 804 that provides both coherent radiation and phase-sensitive amplification. The SQUID loop 804 includes a pair of Josephson junctions 806a and 806b that couple inductively to an inductor in a pump transmission line 802 that guides a pump beam at a wavelength δ/2 (e.g., corresponding to a frequency of hundreds of MHz to tens of GHz). The SQUID loop 804 and Josephson junctions 806a, 806b act as a squeezer, emitting as a squeezed RF field. The JPO 800 also includes a superconducting transmission line 808 coupled to the SQUID loop 804 that guides the JPO's output, which is at a wavelength δ. (The

JPO 800 is cooled so that k_{B}T<<ℏω and thermally and seismically isolated from its surroundings.) The superconducting transmission line 808 and a capacitor 810 in series with the superconducting transmission line 808 provide passive phase stabilization of the JPO's output: the length and impedance of the superconducting transmission line 808 and the impedance of the capacitor 810 are selected to ensure a phase-stable relationship between the pump beam and the JPO's output. The impedances of the superconducting transmission line 808 and the capacitor 810 should be chosen such that the superconducting transmission line's dispersion is equivalent to that of a pure time delay near the oscillator's resonant frequency.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including clements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.c., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. CLAIMS

1. A feedback oscillator comprising:
a source configured to emit coherent radiation;
a phase-sensitive amplifier configured to emit a squeezed field; and
a phase stabilizer, operably coupled to the source and the phase-sensitive amplifier, to stabilize a phase of the coherent radiation relative to a phase of the squeezed field.

2. The feedback oscillator of claim 1, wherein the feedback oscillator is configured to emit an output with a linewidth below the Schalow-Townes limit.

3. The feedback oscillator of claim 1, wherein the phase-sensitive amplifier is configured to amplify an amplitude quadrature of the coherent radiation.

4. The feedback oscillator of claim 1, wherein the phase-sensitive amplifier is configured to emit the squeezed field as a squeezed vacuum.

5. The feedback oscillator of claim 1, wherein the phase-sensitive amplifier is configured to emit the squeezed field as a squeezed bright field.

6. The feedback oscillator of claim 1, wherein the phase-sensitive amplifier comprises:
a phase-insensitive amplifier to amplify the coherent radiation; and
a squeezer, operably coupled to the phase-insensitive amplifier, to generate the squeezed field from the coherent radiation.

7. The feedback oscillator of claim 1, wherein the feedback oscillator is an optoelectronic oscillator, the source comprises a laser, the phase-sensitive amplifier comprise an optical parametric amplifier configured to emit the squeezed field as a squeezed bright field, and the phase stabilizer comprises a feedback loop configured to lock a phase of the coherent radiation to the optical parametric amplifier.

8. The feedback oscillator of claim 7, wherein the optical parametric amplifier is in a positive feedback loop configured to act on a modulated copy of the coherent radiation.

9. The feedback oscillator of claim 7, wherein the feedback oscillator further comprises:
an amplitude modulator, in optical communication with the laser, to modulate an amplitude of the coherent radiation;
a delay line, in optical communication with the amplitude modulator and the phase- sensitive amplifier, to delay the coherent radiation;
a photodetector, in optical communication with the phase-sensitive amplifier, to transduce the squeezed bright field into a radio-frequency signal dominated by shot noise generated by detection of the squeezed bright field; and
a power splitter, operably coupled to the photodetector and the amplitude modulator, to drive the amplitude modulator with a first portion of the radio-frequency signal and to emit a second portion of the radio-frequency signal as an output of the feedback oscillator.

10. The feedback oscillator of claim 9, wherein the optical parametric amplifier comprises:
a pump laser to emit a pump beam;
a radio-frequency synthesizer to generate a local oscillator;
a mixer, operably coupled to the radio-frequency synthesizer and to the photodetector, to mix the local oscillator with a component of the radio-frequency signal so as to generate an error signal; and
a phase modulator, operably coupled to the mixer and the pump laser, to modulate a phase of the pump beam in response to the error signal.

11. The feedback oscillator of claim 10, wherein the mixer is configured to control a squeezing angle of the squeezed bright field.

12. The feedback oscillator of claim 10, wherein the optical parametric amplifier comprises:
a second-order nonlinear medium, disposed in cavity in optical communication with the pump laser, to generate the squeezed bright field via a parametric interaction between the pump beam and the coherent radiation.

13. The feedback oscillator of claim 1, wherein the feedback oscillator is a laser configured to emit a laser beam, the source comprises a gain medium in a laser cavity of the laser, the phase- sensitive amplifier comprises an optical parametric amplifier configured to emit the squeezed field as a squeezed vacuum and to couple the squeezed vacuum into the laser cavity, and the phase stabilizer is configured to lock a phase angle of the optical parametric amplifier to a phase of the laser beam.

14. The feedback oscillator of claim 13, wherein the optical parametric amplifier comprises:
a pump laser to generate a pump beam; and
a second-order nonlinear medium to generate the squeezed vacuum via a parametric interaction between the pump beam and the laser beam.

15. The feedback oscillator of claim 13, wherein the phase stabilizer is configured to align a phase quadrature of the squeezed vacuum to a phase quadrature of the laser beam.

16. The feedback oscillator of claim 1, wherein the feedback oscillator is an optical parametric oscillator configured to emit an output at an output frequency, the source comprises a pump laser that emits the coherent radiation at a pump frequency equal to twice the output frequency, the phase-sensitive amplifier comprises a nonlinear medium in a cavity and configured to emit the squeezed field as a squeezed bright field at the output frequency, and the phase stabilizer is configured to stabilize the pump frequency to the cavity.

17. The feedback oscillator of claim 1, wherein the feedback oscillator is a Josephson parametric oscillator, the source comprises a pump transmission line, the phase-sensitive amplifier comprises a superconducting quantum interference device (SQUID) loop, and the phase stabilizer comprises a superconducting transmission line and a capacitor impedance- matched to a pump transmission line.

18. A method of generating an oscillatory signal with a linewidth below the Schalow-Townes limit, the method comprising:
emitting coherent radiation from a source;
generating a squeezed field based on the coherent radiation with a phase-sensitive amplifier; and
stabilizing a phase of the coherent radiation relative to a phase of the squeezed field.

19. The method of claim 18. wherein generating the squeezed field comprises amplifying an amplitude quadrature of the coherent radiation.

20. The method of claim 18. wherein generating the squeezed field comprises aligning a phase quadrature of the squeezed field to a phase quadrature of the coherent radiation.
